(19) United States
(12) Patent Application Publication
(10) Pub. No.: US 2007/0039478 A1
(43) Pub. Date: Feb. 22, 2007

(54) Coffee machine brew head

(75) Inventor: Dicken Man Chiu Ng, Aberdeen (HK)

Correspondence Address: LEYDIG VOIT & MAYER, LTD, 700 THIRTEENTH ST. NW, SUITE 300, WASHINGTON, DC, 20005-3960, US

(73) Assignee: Main Power Electrical Factory Ltd., Kwun Tong (HK)

(21) Appl. No.: 11/211,089

(22) Filed: Aug. 25, 2005

Related U.S. Application Data
(63) Continuation-in-part of application No. 11/208,013, filed on Aug. 22, 2005, now abandoned.

(51) Int. Cl. A47J 31/44

(52) U.S. Cl. 99/279

(57) ABSTRACT

A coffee machine brew head has a body with a pivotally connected closure. The body has a recess for a coffee holding device. The closure closes the recess to define a coffee brewing chamber. A pivotal handle of the brew head is movable in a closing direction and an opening direction. The brew head has a bayonet lock with a stationary part and a rotational part that is movable with or by the handle for locking and unlocking the closure when the handle is moved in the closing and opening directions respectively.

### BACKGROUND TO THE INVENTION

1. Field of the Invention

The current invention relates to coffee machines, and in particular to a coffee machine brew head.

2. Background Information

Known espresso coffee makers use the well known bayonet-type twist-and-lock connection of sieve holder and brew head. The sieve holder must be manually aligned to mate with a flange at lower part of the brew head and then rotated, or twisted, to lock and seal the sieve holder to the brew head tightly before brewing starts. Aligning the sieve holder with the brew head flange using only one hand can be difficult for novice or non-dexterous operators to master. Often two hands are need for the locking operation. One hand is used to align and twist the sieve holder and the other for holding the coffee machine to aid coordination and ensure tight locking.

### SUMMARY OF THE INVENTION

It is an object of the present invention to overcome or substantially ameliorate at least one of the above problem and/or more generally to provide an improved coffee machine brew head that is simple to use or provides the public with a useful alternative.

There is disclosed herein a coffee machine brew head comprising a brew head body having a recess for a coffee holding device and a water outlet passage from the recess, a brew head closure pivotally connected to the brew head body and having a closed position closing the recess, an inlet passage for delivering hot water to the recess, a rotational lock for securing the brew head closure in the closed position, a beveled gear connected to the rotational lock, and a pivotal handle having an open position and a closed position and a pinion gear for rotating the beveled gear and lock when the handle is moved between the open and closed positions.

Preferably, the rotational lock is a bayonet lock having a stationery locking part located on the brew head body and a rotational locking part located on the brew head closure.

Preferably, the rotational lock is a twist and lock bayonet lock having a male locking ring with a plurality of bayonet lugs and a female locking ring having a plurality of corresponding tabs or groves for providing a locking interaction with the bayonet lugs.

Preferably, the male locking ring, beveled gear and handle are located on the brew head closure.

Preferably, the female locking ring is located on the brew head body concentric with the recess.

Preferably, the female locking ring has a gap for a handle of the coffee holding device.

Preferably, the brew head closure pivots about a first axis and the handle pivots about a second axis parallel with the first axis.

Preferably, the lock and beveled gear are rotational about a third axis perpendicular to the second axis.

Preferably, the brew head further includes a spreader connected to the inlet passage for evenly distributing hot water within the recess.

### BRIEF DESCRIPTION OF THE DRAWINGS

A preferred embodiment of the present invention will now be described by way of example only and with reference to the accompanying drawings in which:

FIG. 1 is a front perspective schematic view of a coffee machine brew head according to the invention in a closed and unlocked configuration,

FIG. 2 is a rear perspective schematic view of the brew head in the closed and unlocked configuration,

FIG. 3 is a second front perspective schematic view of the brew head in an open configuration, and

FIG. 4 is a third front perspective schematic view of the brew head in a closed and locked configuration.

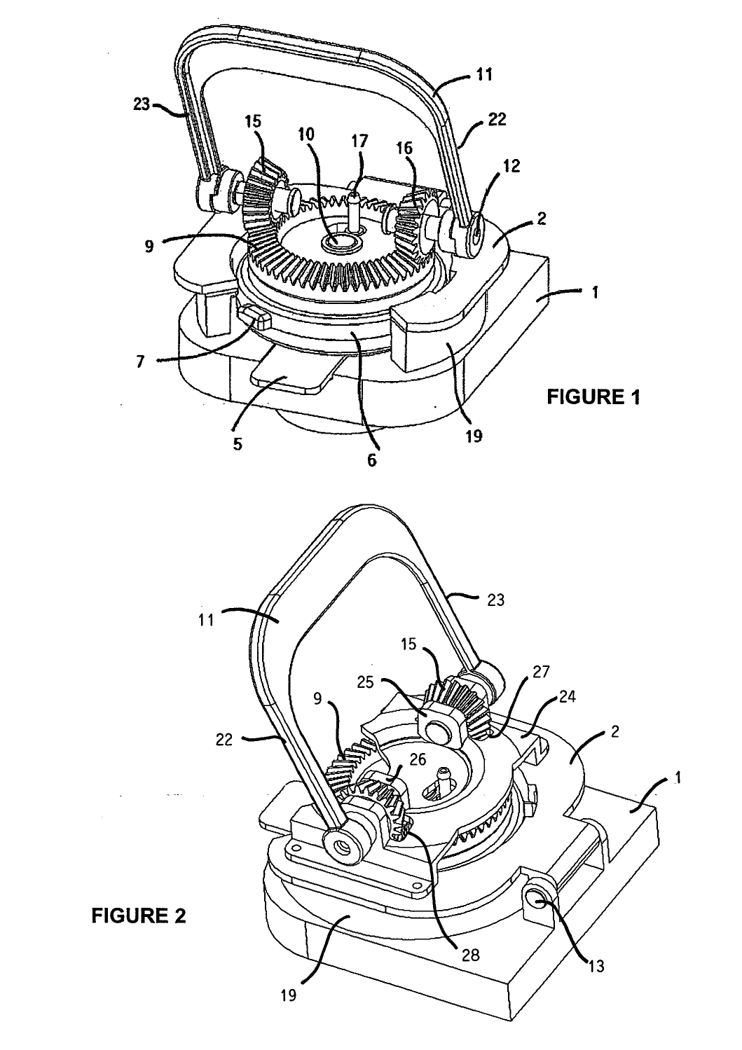

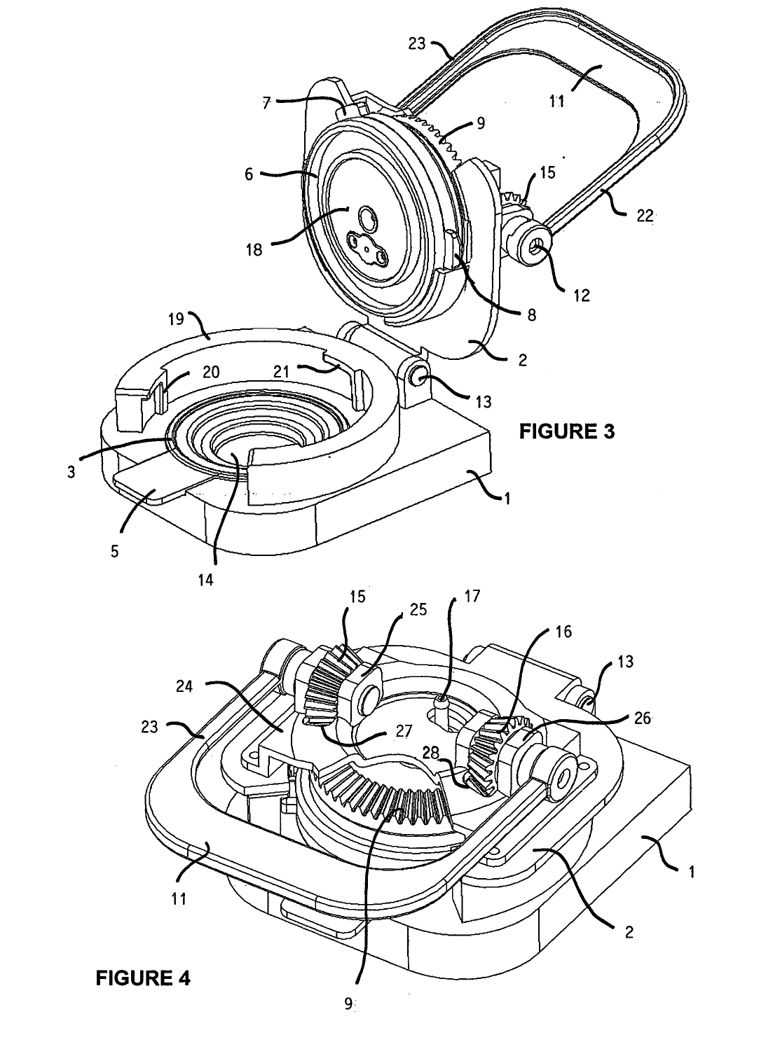

### DETAILED DESCRIPTION OF THE DRAWINGS

In the accompanying drawings there is depicted a coffee machine brew head having a body 1 with a pivotally attached closure 2. The brew head body 1 has a centrally located recess 3 for receiving a coffee holding device such as portafilter 4. In alternative embodiments the recess may hold coffee pods, filter baskets and like equipment. The recess 3 has an outlet passage 14 to allow coffee infused hot water to flow into a carafe or portafilter spout. A female locking ring 19 is located on the brew head body 1 concentric with the recess 3 and has a plurality of locking tabs 20, 21 around its inner parameter. The female locking ring 19 has a gap to allow the handle 5 of portafilter 4 to extend from the body 1.

The brew head closure 2 is pivotally connected to the brew head body 1 about closure axis 13 and closes the recess 3 to define a coffee brewing chamber. A male locking ring 6 is rotationally mounted about a locking axis 10 on the underside of closure 2. The male locking ring 6 has a plurality of radial locking lugs 7, 8 located about its outer periphery. The locking lugs 7, 8 provided a bayonet locking arrangement with corresponding locking tabs 20, 21 of female locking ring 19.

A beveled crown wheel 9 is located on locking axis 10 on the top side of closure 2. The crown wheel 9 is fixed with male locking ring 6 for causing it to rotate when crown wheel 9 is rotated.

A frame 24 is mounted on the top of closure 2 for supporting a U-shaped handle 11 having extending arms 22, 23 with a boss at their distal ends. The handle 11 is pivotally connected to tabs 25, 26 of the frame 24 by stub shafts extending through each boss along a handle axis 12. The handle 11 is movable in an opening direction and a closing direction about the handle axis 12. The frame 24 has openings 27, 28 so that two beveled pinion gears 15, 16 mounted on respective stub shafts engage with the beveled crown wheel 9. The first beveled pinion gear 15 is fixed with handle arm 23 for driving the crown wheel 9 when the handle 11 is moved in either the opening direction or the closing direction. The second pinion gear 16 freewheels on its stub shaft independent of handle 11 movement.

The frame 24 supporting handle 11 is absent from FIG. 1 to illustrate the two beveled pinion gears 15, 16 and crown wheel 9.

A water spreader 18 is located on the underside of closure 2 within male locking ring 6. The spreader 18 is connected to a water inlet passage 17 for the introduction of hot water into the recess brewing chamber. The spreader 18 has a well-known arrangement for evenly distributing water over coffee grounds within portafilter 4.

In the preferred embodiment the closure axis 13 and handle axis 12 are parallel so that a single opening or closing movement of the handle both unlocks and opens the closure, or closes and locks the closure respectively. This allows for efficient single-handed opening and closing of the brew head for changing the coffee grounds.

It should be appreciated that modifications and alternations obvious to those skilled in the art are not to be considered as beyond the scope of the present invention. For example, the locking tabs 20, 21 of female locking ring 19 may be replaced with locking grooves for interaction with the locking lugs 7, 8 of male locking ring 6. Also, a specific embodiment of a rotational bayonet-type lock has been described however it should be understood that any bayonet-type locking arrangement having a first stationery locking part located on the brew head body and a second rotational locking part located on the brew head closure may be used. Alternatively, the stationary part could be on the closure and the rotational part on the body.

What is claimed is:

1. A coffee machine brew head comprising:
a brew head body having a recess for a coffee holding device and a water outlet passage from the recess,
a brew head closure pivotally connected to the brew head body and having a closed position closing the recess,
an inlet passage for delivering hot water to the recess,
a pivotal handle movable in a closing direction and an opening direction, and
a bayonet lock having a stationary part and a rotational part movable with or by the handle for locking and unlocking the closure in the closed position when the handle is moved in the closing and opening directions respectively.

2. A coffee machine brew head comprising:
a brew head body having a recess for a coffee holding device and a water outlet passage from the recess,
a brew head closure pivotally connected to the brew head body and having a closed position closing the recess,
an inlet passage for delivering hot water to the recess,
a rotational lock for securing the brew head closure in the closed position,
a beveled gear connected to the rotational lock, and
a pivotal handle having an open position and a closed position and a pinion gear for rotating the beveled gear and lock when the handle is moved between the open and closed positions.

3. The brew head of claim 2 wherein the rotational lock is a bayonet lock having a stationery locking part located on the brew head body and a rotational locking part located on the brew head closure.

4. The brew head of claim 2 wherein the rotational lock is a bayonet lock having a male locking ring with a plurality of bayonet lugs and a female locking ring having a plurality of corresponding tabs or groves for providing a locking interaction with the bayonet lugs.

5. The brew head of claim 3 wherein the male locking ring, beveled gear and handle are located on the brew head closure.

6. The brew head of claim 3 wherein the female locking ring is located on the brew head body concentric with the recess.

7. The brew head of claim 6 wherein the female locking ring has a gap for a handle of the coffee holding device.

8. The brew head of claim 5 wherein the brew head closure pivots about a first axis and the handle pivots about a second axis parallel with the first axis.

9. The brew head of claim 8 wherein the lock and beveled gear are rotational about a third axis perpendicular to the second axis.

10. The brew head of claim 2 further including a spreader connected to the inlet passage for evenly distributing hot water within the recess.

11. A coffee machine brew head comprising:
a brew head body having a recess for a coffee holding device and a water outlet passage from the recess,
a brew head closure pivotally connected to the brew head body about a first axis and having a closed position closing the recess,
an inlet passage for delivering hot water to the recess,
a first locking ring having a plurality of radial lugs located on the closure and rotational about a second axis,
a beveled gear coaxial with the first locking ring and fixed with the first locking ring,
a handle located on the closure and pivotal about a third axis parallel with the first axis, the handle having an open position and a closed position and a pinion gear coupled with the beveled gear for moving the beveled gear when the handle is moved between the open and closed positions, and
a second locking ring located on the brew head body and having a plurality of corresponding tabs or groves for providing a locking interaction with the radial lugs.
